(19) United States
(12) Patent Application Publication
(10) Pub. No.: US 2019/0279187 A1
(43) Pub. Date: Sep. 12, 2019

(54) ELECTRONIC DEVICE AND PAYMENT EXECUTION METHOD USING ELECTRONIC DEVICE

(71) Applicant: Samsung Electronics Co., Ltd., Suwon-si, Gyeonggi-do (KR)

(72) Inventor: Kyungdong KIM, Suwon-si (KR)

(21) Appl. No.: 16/349,062

(22) PCT Filed: Nov. 22, 2017
(86) PCT No.: PCT/KR2017/013314

§ 371 Date: May 10, 2019

(30) Foreign Application Priority Data
Nov. 22, 2016 (KR) 10-2016-0155518

(51) Int. Cl. G06Q 20/22; G06Q 20/32; G06Q 20/40

(52) U.S. Cl. CPC G06Q 20/29; G06Q 20/3278; G06Q 20/40; G06Q 20/322

(57) ABSTRACT

According to various embodiments, an electronic device and an operating method for an electronic device can comprise a display, a communication module, and a processor, which: controls the communication module such that data including a list of users, including a user of the electronic device, who intend to make a partial payment is transmitted to a first server; makes a request such that the first server acquires payment information corresponding to each user who intends to make the partial payment; receives payment information, corresponding to the user of the electronic device, among pieces of the payment information corresponding to each user who intends to make the partial payment, and controls the execution of the partial payment by using the payment information corresponding to the user of the electronic device. Therefore, all persons participating in a payment can partially pay even if one user among a plurality of users participating in the payment makes a mobile payment by using the user's own electronic device, and thus the inconvenience of many people having to make a partial payment while waiting can be resolved.

### TECHNICAL FIELD

Various embodiments of the disclosure relate to an electronic device and a method for performing a payment using the electronic device, and more particularly, to technology to perform a divided payment using an electronic device.

### BACKGROUND ART

With the spread of various electronic devices, such as smart phone, tablet PC, portable multimedia player (PMP), personal digital assistant (PDA), laptop personal computer (laptop PC), and wearable device, there has been an increasing concern about technology to perform mobile payments using various electronic devices.

The mobile payment has the advantage that it is possible to perform a payment without providing a separate credit card or check card based on the characteristic of the electronic device that is always carried by a user.

Further, in performing mobile payments using various electronic devices, technology has been developed, whereby a plurality of users can make divided payments of a payment amount.

### DISCLOSURE OF INVENTION

### Technical Problem

In the case where several persons make divided payments, even mobile payments cause inconvenience in use in the same manner as payments by physical cards, and it takes a lot of time in performing such mobile payments. For example, in the case where three persons perform mobile divided payments, they wait for their turns and make payments of their shared amounts, respectively, and thus advantages of accepting the mobile payments are reduced.

Further, in the case where one of users who intend to make divided payments pays the total payment amount as a representative, and the remaining users excluding the representative remit their shared amounts to the representative, it is required for the representative to individually identify whether other users have remitted their shared amounts.

### Solution to Problem

Various embodiments of the disclosure are to solve the above-described problems and to simply perform divided payments.

According to various embodiments of the disclosure, an electronic device includes a display; a communication module; and a processor configured to control the communication module to transmit, to a first server, data including a list of users, including a user of the electronic device, to perform divided payments, request the first server to acquire payment information corresponding to the respective users to perform the divided payments, and control the communication module to receive payment information corresponding to the user of the electronic device among the payment information corresponding to the respective users to perform the divided payments.

According to various embodiments of the disclosure, an electronic device includes a communication module configured to perform communication with an external electronic device; and a processor configured to control the communication module to receive, from the external electronic device, data including a list of users to perform divided payments, acquire payment information corresponding to the respective users included in the list, transmit, to the electronic device, payment information corresponding to a user of the electronic device, and transmit, to a second external server, payment information corresponding to the at least one remaining user in response to reception of the payment information, corresponding to the user of the electronic device, transmitted from a first external server.

According to various embodiments of the disclosure, a method for performing a payment of an electronic device includes transmitting, to a first server, data including a list of users, including a user of the electronic device, to perform divided payments, requesting the first server to acquire payment information corresponding to the respective users to perform the divided payments, and transmitting a message for requesting payment information corresponding to the user of the electronic device to the first server, and receiving the payment information corresponding to the user of the electronic device.

### Advantageous Effects of Invention

According to the electronic device and the operating method of the electronic device according to the embodiments of the disclosure, a plurality of users participating in divided payments can perform the divided payments in all even if one of the users participating in the divided payments performs a mobile payment using his/her own electronic device when the mobile divided payments are performed, and thus it is not required for the plurality of persons to wait for their turns to make the divided payments.

Further, in the case where one of the plurality of users performs the mobile payment, the payment information of other users is not stored in the electronic device of the user who performs the mobile payment, and thus security can be improved.

### BRIEF DESCRIPTION OF DRAWINGS

FIG. 1 is a diagram illustrating an electronic device in a network environment according to various embodiments of the disclosure;

FIG. 2 is a block diagram of an electronic device according to various embodiments of the disclosure;

FIG. 3 is a block diagram of a program module according to various embodiments of the disclosure;

FIG. 4 is a diagram illustrating subjects that perform divided payments according to various embodiments of the disclosure;

FIG. 5 is an operational flowchart illustrating a method for performing divided payments through subjects that perform the divided payments;

FIG. 6A is a block diagram illustrating the configuration of an electronic device among the subjects that perform the divided payments as illustrated in FIG. 4;

FIG. 6B is a block diagram illustrating the configuration of a first server among the subjects that perform the divided payments as illustrated in FIG. 4;

FIG. 7A is a diagram illustrating an embodiment of a screen for selecting users who perform divided payments, and FIG. 7B is a diagram illustrating an embodiment of a screen for selecting users who perform divided payments;

FIG. 7C is a diagram illustrating an embodiment of a screen for approving divided payments through electronic devices corresponding to users who perform the divided payments;

FIG. 8 is a diagram illustrating a method for performing a payment of an electronic device according to various embodiments of the disclosure;

FIG. 9 is a diagram illustrating a method for performing a payment of an electronic device according to another embodiment of the disclosure;

FIG. 10 is a diagram illustrating an operating method of a first server used to perform a divided payment through an electronic device according to various embodiments of the disclosure; and

FIG. 11 is a diagram illustrating an operating method of a second server used to perform a divided payment through an electronic device according to various embodiments of the disclosure.

### MODE FOR THE INVENTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the present disclosure. In addition, descriptions of well-known functions and constructions may be omitted for clarity and conciseness. The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents. As used herein, the singular forms “a”, “an”, and “the” are intended to include the plural forms, including “at least one”, unless the content clearly indicates otherwise. “Or” means “and/or”. As used herein, the term “and/or” includes any and all combinations of one or more of the associated listed items. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

It will be understood that, although the terms “first”, “second”, “third”, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element”, “component”, “region”, “layer” or “section” discussed below could be termed a second element, component, region, layer or section without departing from the teachings herein.

In this disclosure, an electronic device may be a device that involves a communication function. For example, an electronic device may be a smart phone, a tablet PC (Personal Computer), a mobile phone, a video phone, an e-book reader, a desktop PC, a laptop PC, a netbook computer, a PDA (Personal Digital Assistant), a PMP (Portable Multimedia Player), an MP3 player, a portable medical device, a digital camera, or a wearable device (e.g., an HMD (Head-Mounted Device) such as electronic glasses, electronic clothes, an electronic bracelet, an electronic necklace, an electronic appcessory, or a smart watch).

According to some embodiments, an electronic device may be a smart home appliance that involves a communication function. For example, an electronic device may be a TV, a DVD (Digital Video Disk) player, audio equipment, a refrigerator, an air conditioner, a vacuum cleaner, an oven, a microwave, a washing machine, an air cleaner, a set-top box, a TV box (e.g., Samsung HomeSync™, Apple TV™, Google TV™, etc.), a game console, an electronic dictionary, an electronic key, a camcorder, or an electronic picture frame. According to some embodiments, an electronic device may be a medical device (e.g., MRA (Magnetic Resonance Angiography), MRI (Magnetic Resonance Imaging), CT (Computed Tomography), ultrasonography, etc.), a navigation device, a GPS (Global Positioning System) receiver, an EDR (Event Data Recorder), an FDR (Flight Data Recorder), a car infotainment device, electronic equipment for ship (e.g., a marine navigation system, a gyrocompass, etc.), avionics, security equipment, or an industrial or home robot. According to some embodiments, an electronic device may be furniture or part of a building or construction having a communication function, an electronic board, an electronic signature receiving device, a projector, or various measuring instruments (e.g., a water meter, an electric meter, a gas meter, a wave meter, etc.). An electronic device disclosed herein may be one of the above-mentioned devices or any combination thereof. As well understood by those skilled in the art, the above-mentioned electronic devices are exemplary only and not to be considered as a limitation of this disclosure.

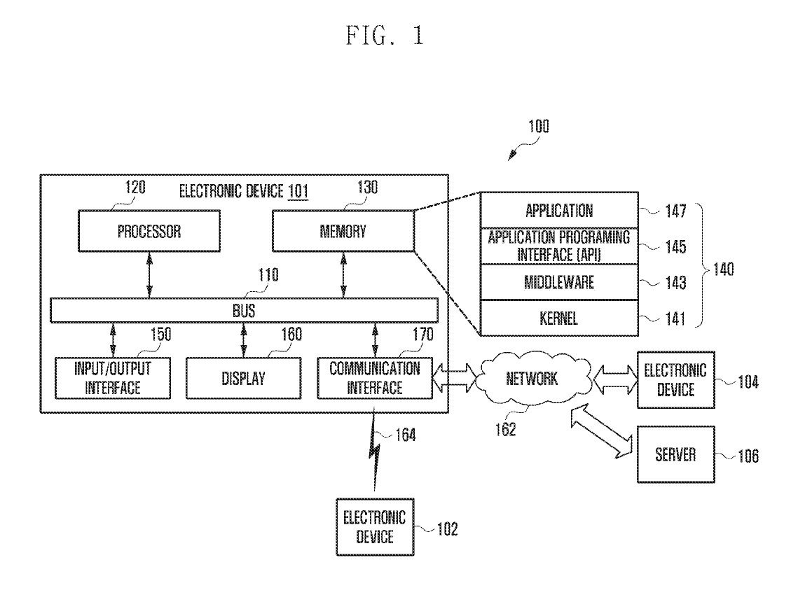

FIG. 1 is a block diagram illustrating a configuration of an electronic device according to an embodiment of the present disclosure. Referring to FIG. 1, the electronic device 100 may include a bus 110, a processor 120, a memory 130, a user input module 140, a display module 150, a communication module 160, and other similar and/or suitable components. The bus 110 may be a circuit which interconnects the above-described elements and delivers a communication (e.g., a control message) between the above-described elements. The processor 120 may receive commands from the above-described other elements (e.g., the memory 130, the user input module 140, the display module 150, the communication module 160, etc.) through the bus 110, may interpret the received commands, and may execute calculation or data processing according to the interpreted commands.

The memory 130 may store commands or data received from the processor 120 or other elements (e.g., the I/O module 150, the display module 160, the communication module 170, and the like) or generated by the processor 120 or the other elements. The memory 130 may include programming modules, such as a kernel 141, middleware 143, an application programming interface (API) 145, an application 147, and the like. Each of the above-described programming modules may be implemented in software, firmware, hardware, or a combination of two or more thereof. The kernel 141 may control or manage system resources (e.g., the bus 110, the processor 120, the memory 130, and the like) used to execute operations or functions implemented by other programming modules (e.g., the middleware 143, the API 145, and the application 147). In addition, the kernel 141 may provide an interface capable of accessing and controlling or managing the individual elements of the electronic device 100 by using the middleware 143, the API 145, or the application 147.

The middleware 143 may interconnect the API 145 or the applications 147 and the kernel 141 in such a manner that the API 145 or at least one of the applications 147 communicates with the kernel 141 and exchanges data therewith. In relation to work requests received from one or more applications 140, the middleware 143 may perform load balancing of the work requests by using a method of assigning a priority, in which system resources of the electronic device 100 can be used, to at least one of the one or more applications 140. The API 145 is an interface through which at least one of the applications 147 is capable of controlling a function provided by the kernel 141 or the middleware 143, and may include at least one interface or function for file, window, image processing, and character control.

The input/output interface 150 may include various interface circuitry may receive a command or data as input from a user, and may deliver the received command or data to the processor 120 or the memory 130 through the bus 110. The display 160 may display a video, an image, and data to the user.

The communication interface 170 may include various communication circuitry and connect communication between electronic devices 102 and 104 and the electronic device 100. The communication interface 170 may support a short-range communication protocol 164, such as Wi-Fi, Bluetooth (BT), and near field communication (NFC), or a network communication 162, such as the Internet, a local area network (LAN), a wide area network (WAN), a telecommunication network, a cellular network, a satellite network, and a plain old telephone service (POTS). Each of the electronic devices 102 and 104 may be of an identical type as, or a different type than, the electronic device 100. The communication interface 170 may connect communication between a server 106 and the electronic device 100 via the network 162.

The term “module” used in the present disclosure may refer to, for example, a unit including one or more combinations of hardware, software, and firmware. The “module” may be interchangeable with a term, such as “unit,” “logic,” “logical block,” “component,” “circuit,” and the like. The “module” may be a minimum unit of a component formed as one body or a part thereof. The “module” may be a minimum unit for performing one or more functions or a part thereof. The “module” may be implemented mechanically or electronically. For example, the “module” according to an example embodiment of the present disclosure may include at least one of a dedicated processor, a CPU, an application-specific integrated circuit (ASIC) chip, a field-programmable gate array (FPGA), and a programmable-logic device for performing certain operations which have been known or are to be developed in the future.

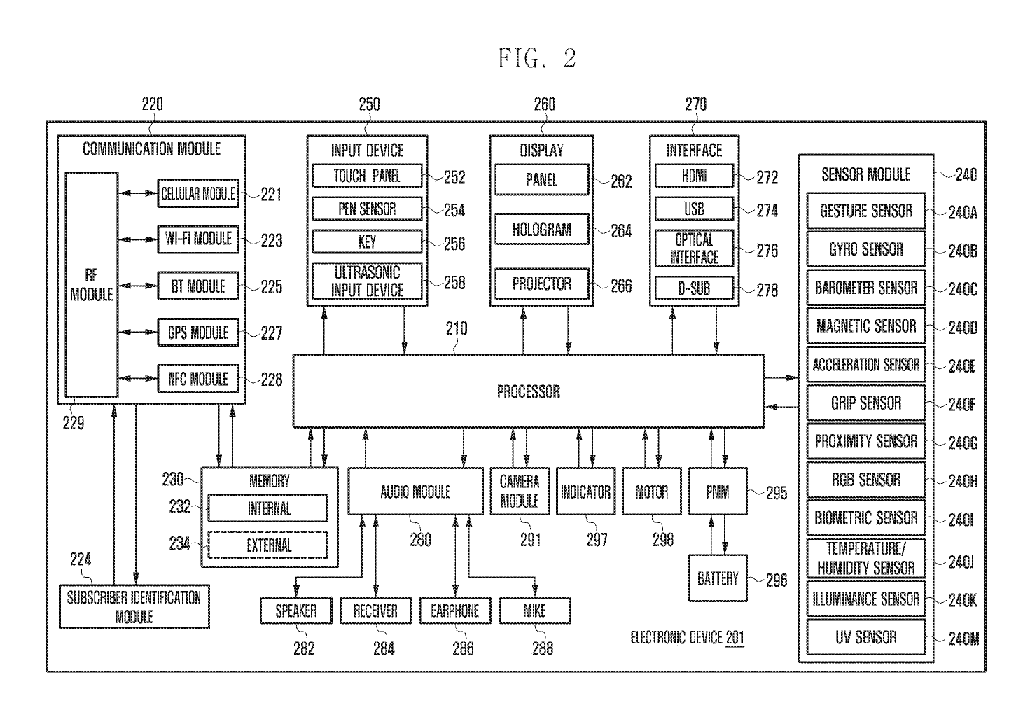

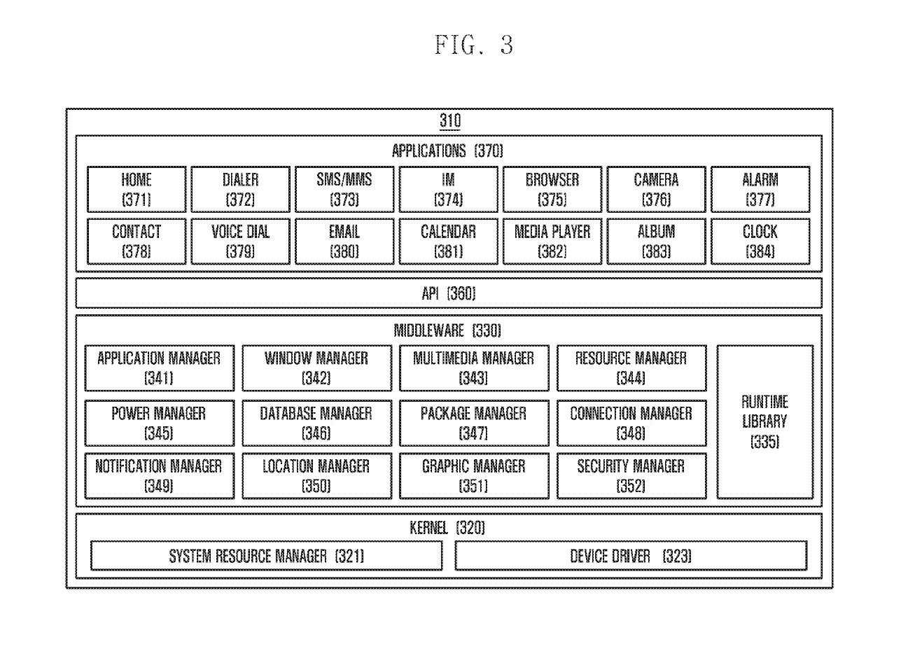

FIG. 2 is a block diagram illustrating an example electronic device according to one example embodiment of the present disclosure. Referring to FIG. 2, an electronic device 201 may be, for example, the electronic device 101 illustrated in FIG. 1. Referring to FIG. 2, the electronic device 201 may include a processor (e.g., and application processor including processing circuitry) 210, a subscriber identification module (SIM) card 224, a memory 230, a communication module (e.g., including communication circuitry) 220, a sensor module 240, an input device (e.g., including input circuitry) 250, a display 260, an interface (e.g., including interface circuitry) 270, an audio module (coder/decoder (codec)) 280, a camera module 291, a power management module 295, a battery 296, an indicator 297, a motor 298 and any other similar and/or suitable components. The processor 210 may include various processing circuitry, such as, for example, and without limitation, one or more of a dedicated processor, a CPU, application processors (APs) (not illustrated), or one or more communication processors (CPs) (not illustrated). The processor 210 may be, for example, the processor 120 illustrated in FIG. 1. The AP and the CP may be included in the processor 210 in FIG. 2, or may be included in different integrated circuit (IC) packages, respectively. According to an embodiment of the present disclosure, the AP and the CP may be included in one IC package. The AP may execute an operating system (OS) or an application program, and thereby may control multiple hardware or software elements connected to the AP and may perform processing of and arithmetic operations on various data including multimedia data. The AP may be implemented by, for example, a system on chip (SoC). According to an embodiment of the present disclosure, the processor 210 may further include a graphical processing unit (GPU) (not illustrated).

The CP may manage a data line and may convert a communication protocol in the case of communication between the electronic device (e.g., the electronic device 101) including the electronic device 201 and different electronic devices connected to the electronic device through the network. The CP may be implemented by, for example, an SoC. According to an embodiment of the present disclosure, the CP may perform at least some of multimedia control functions. The CP, for example, may distinguish and authenticate a terminal in a communication network by using a SIM (e.g., the SIM card 224). In addition, the CP may provide the user with services, such as a voice telephony call, a video telephony call, a text message, packet data, and the like. Further, the CP may control the transmission and reception of data by the communication module 220. In FIG. 2, the elements, such as the power management module 295, the memory 230, and the like are illustrated as elements separate from the processor 210. However, according to an embodiment of the present disclosure, the processor 210 may include at least some of the above-described elements (e.g., the power management module 295).

According to an example embodiment of the present disclosure, the AP or the CP may load, to a volatile memory, a command or data received from at least one of a non-volatile memory and other elements connected to each of the AP and the CP, and may process the loaded command or data. In addition, the AP or the CP may store, in a non-volatile memory, data received from or generated by at least one of the other elements.

The SIM card 224 may be a card implementing a SIM, and may be inserted into a slot formed in a particular portion of the electronic device 201. The SIM card 224 may include unique identification information (e.g., IC card identifier (ICCID)) or subscriber information (e.g., international mobile subscriber identity (IMSI)).

The memory 230 may include an internal memory 232 and/or an external memory 234. The memory 230 may be, for example, the memory 130 illustrated in FIG. 1. The internal memory 232 may include, for example, at least one of a volatile memory (e.g., a dynamic random access memory (DRAM), a static RAM (SRAM), a synchronous dynamic RAM (SDRAM), and the like), and a non-volatile memory (e.g., a one time programmable read only memory (OTPROM), a programmable ROM (PROM), an erasable and programmable ROM (EPROM), an electrically erasable and programmable ROM (EEPROM), a mask ROM, a flash ROM, a not AND (NAND) flash memory, a not OR (NOR) flash memory, and the like). According to an embodiment of the present disclosure, the internal memory 232 may be in the form of a solid state drive (SSD). The external memory 234 may further include a flash drive, for example, a compact flash (CF), a secure digital (SD), a micro-SD, a mini-SD, an extreme digital (xD), a memory stick, and the like.

The sensor module 240 may include, for example, at least one of a gesture sensor 240A, a gyro sensor 240B, an atmospheric pressure (e.g., barometer) sensor 240C, a magnetic sensor 240D, an acceleration sensor 240E, a grip sensor 240F, a proximity sensor 240G, a red, green and blue (RGB) sensor 240H, a biometric sensor 2401, a temperature/humidity sensor 240J, an illuminance (e.g., light) sensor 240K, and an ultra violet (UV) sensor 240M. The sensor module 240 may measure a physical quantity or may detect an operating state of the electronic device 201, and may convert the measured or detected information to an electrical signal. Additionally/alternatively, the sensor module 240 may include, for example, an electronic nose (E-nose) sensor (not illustrated), an electromyography (EMG) sensor (not illustrated), an electroencephalogram (EEG) sensor (not illustrated), an electrocardiogram (ECG) sensor (not illustrated), a fingerprint sensor (not illustrated), and the like. Additionally or alternatively, the sensor module 240 may include, for example, an E-nose sensor (not illustrated), an EMG sensor (not illustrated), an EEG sensor (not illustrated), an ECG sensor (not illustrated), a fingerprint sensor, and the like. The sensor module 240 may further include a control circuit (not illustrated) for controlling one or more sensors included therein. The sensor module 240 may also, or in the alternative, be controlled by the processor 210.

The input device 250 may include various input circuitry, such as, for example, and without limitation, a touch panel 252, a pen sensor 254 (e.g., a digital pen sensor), keys 256, and an ultrasonic input device 258. The input device 250 may be, for example, the input/output interface 150 illustrated in FIG. 1. The touch panel 252 may recognize a touch input in at least one of, for example, a capacitive scheme, a resistive scheme, an infrared scheme, and an acoustic wave scheme. In addition, the touch panel 252 may further include a controller (not illustrated). In the capacitive type, the touch panel 252 is capable of recognizing proximity as well as a direct touch. The touch panel 252 may further include a tactile layer (not illustrated). In this event, the touch panel 252 may provide a tactile response to the user. The pen sensor 254 (e.g., a digital pen sensor), for example, may be implemented by using a method identical or similar to a method of receiving a touch input from the user, or by using a separate sheet for recognition. For example, a key pad or a touch key may be used as the keys 256. The ultrasonic input device 258 enables the terminal to detect a sound wave by using a microphone (e.g., a microphone 288) of the terminal through a pen generating an ultrasonic signal, and to identify data. The ultrasonic input device 258 is capable of wireless recognition. According to an embodiment of the present disclosure, the electronic device 201 may receive a user input from an external device (e.g., a network, a computer, or a server), which is connected to the electronic device 201, through the communication module 220.

The display 260 may include a panel 262, a hologram 264, and a projector 266. The display 260 may be, for example, the display 160 illustrated in FIG. 1. The panel 262 may be, for example, a liquid crystal display (LCD) and an active matrix organic light emitting diode (AM-OLED) display, or the like, but is not limited thereto. The panel 262 may be implemented so as to be, for example, flexible, transparent, or wearable. The panel 262 may include the touch panel 252 and one module. The hologram 264 may display a three-dimensional image in the air by using interference of light. The projector 266 may include light-projecting elements, such as LEDs, to project light into external surfaces. According to an embodiment of the present disclosure, the display 260 may further include a control circuit for controlling the panel 262, the hologram 264, or the projector 266.The interface 270 may include various interface circuitry, such as, for example, and without limitation, a high-definition multimedia interface (HDMI) 272, a universal serial bus (USB) 274, an optical interface 276, and a d-subminiature (D-sub) 278. Additionally or alternatively, the interface 270 may include, for example, SD/multi-media card (MMC) (not illustrated) or infrared data association (IrDA) (not illustrated).

The audio module (codec) 280 may bidirectionally convert between a voice and an electrical signal. The audio module 280 may convert voice information, which is input to or output from the audio module 280, through, for example, a speaker 282, a receiver 284, an earphone 286, the microphone 288, and the like.

electronic device 201 (e.g., the AP), for example, a booting state, a message state, a charging state and the like. The motor 298 may convert an electrical signal into a mechanical vibration. Although not illustrated, the electronic device 201 may include a processing unit (e.g., a GPU) for supporting a module TV. The processing unit for supporting a module TV may process media data according to standards, such as, for example, digital multimedia broadcasting (DMB), digital video broadcasting (DVB), media flow, and the like. Each of the above-described elements of the electronic device 201 according to an embodiment of the present disclosure may include one or more components, and the name of the relevant element may change depending on the type of electronic device. The electronic device 201 according to an embodiment of the present disclosure may include at least one of the above-described elements. Some of the above-described elements may be omitted from the electronic device 201, or electronic device 201 may further include additional elements. In addition, some of the elements of the electronic device 201 according to an embodiment of the present disclosure may be combined into one entity, which may perform functions identical to those of the relevant elements before the combination.

FIG. 3 is a block diagram illustrating an example configuration of a programming module according to an example embodiment of the present disclosure. Referring to FIG. 3, a programming module 300 may be included (or stored) in the electronic device 101 (e.g., the memory 130) or may be included (or stored) in the electronic device 201 (e.g., the memory 230) illustrated in FIG. 1. At least a part of the programming module 300 may be implemented in software, firmware, hardware, or a combination of two or more thereof. The programming module 300 may be implemented in hardware (e.g., the electronic device 201), and may include an OS controlling resources related to an electronic device (e.g., the electronic device 101) and/or various applications (e.g., an application 370) executed in the OS. For example, the OS may be Android, iOS, Windows, Symbian, Tizen, Bada, and the like. Referring to FIG. 3, the programming module 300 may include a kernel 320, a middleware 330, an API 360, and/or the application 370.

The kernel 320 (e.g., the kernel 141) may include a system resource manager 321 and/or a device driver 323. The system resource manager 321 may include, for example, a process manager (not illustrated), a memory manager (not illustrated), and a file system manager (not illustrated). The system resource manager 321 may perform the control, allocation, recovery, and the like of system resources. The device driver 323 may include, for example, a display driver (not illustrated), a camera driver (not illustrated), a BT driver (not illustrated), a shared memory driver (not illustrated), a USB driver (not illustrated), a keypad driver (not illustrated), a Wi-Fi driver (not illustrated), and/or an audio driver (not illustrated). In addition, according to an embodiment of the present disclosure, the device driver 323 may include an inter-process communication (IPC) driver (not illustrated).The middleware 330 may include multiple modules previously implemented so as to provide a function used in common by the applications 370. In addition, the middleware 330 may provide a function to the applications 370 through the API 360 in order to enable the applications 370 to efficiently use limited system resources within the electronic device. For example, as illustrated in FIG. 3, the middleware 330 (e.g., the middleware 143) may include at least one of a runtime library 335, an application manager 341, a window manager 342, a multimedia manager 343, a resource manager 344, a power manager 345, a database manager 346, a package manager 347, a connectivity manager 348, a notification manager 349, a location manager 350, a graphic manager 351, a security manager 352, and any other suitable and/or similar manager.

The runtime library 335 may include, for example, a library module used by a complier, in order to add a new function by using a programming language during the execution of the application 370. According to an embodiment of the present disclosure, the runtime library 335 may perform functions which are related to input and output, the management of a memory, an arithmetic function, and the like.

The application manager 341 may manage, for example, a life cycle of at least one of the applications 370. The window manager 342 may manage graphical user interface (GUI) resources used on the screen. The multimedia manager 343 may detect a format used to reproduce various media files and may encode or decode a media file through a codec appropriate for the relevant format. The resource manager 344 may manage resources, such as a source code, a memory, a storage space, and the like of at least one of the applications 370. The power manager 345 may operate together with a basic input/output system (BIOS), may manage a battery or power, and may provide power information and the like used for an operation. The database manager 346 may manage a database in such a manner as to enable the generation, search and/or change of the database to be used by at least one of the applications 370. The package manager 347 may manage the installation and/or update of an application distributed in the form of a package file.

The connectivity manager 348 may manage a wireless connectivity, such as, for example, Wi-Fi and BT. The notification manager 349 may display or report, to the user, an event, such as an arrival message, an appointment, a proximity alarm, and the like in such a manner as not to disturb the user. The location manager 350 may manage location information of the electronic device. The graphic manager 351 may manage a graphic effect, which is to be provided to the user, and/or a user interface related to the graphic effect. The security manager 352 may provide various security functions used for system security, user authentication, and the like. According to an embodiment of the present disclosure, when the electronic device (e.g., the electronic device 101) has a telephone function, the middleware 330 may further include a telephony manager (not illustrated) for managing a voice telephony call function and/or a video telephony call function of the electronic device. The middleware 330 may generate and use a new middleware module through various functional combinations of the above-described internal element modules. The middleware 330 may provide modules specialized according to types of OSs in order to provide differentiated functions. In addition, the middleware 330 may dynamically delete some of the existing elements, or may add new elements. Accordingly, the middleware 330 may omit some of the elements described in the various embodiments of the present disclosure, may further include other elements, or may replace the some of the elements with elements, each of which performs a similar function and has a different name. The API 360 (e.g., the API 145) is a set of API programming functions, and may be provided with a different configuration according to an OS. In the case of Android or iOS, for example, one API set may be provided to each platform. In the case of Tizen, for example, two or more API sets may be provided to each platform.

The applications 370 (e.g., the applications 147) may include, for example, a preloaded application and/or a third party application. The applications 370 may include, for example, a home application 371, a dialer application 372, a short message service (SMS)/multimedia message service (MMS) application 373, an instant message (IM) application 374, a browser application 375, a camera application 376, an alarm application 377, a contact application 378, a voice dial application 379, an electronic mail (e-mail) application 380, a calendar application 381, a media player application 382, an album application 383, a clock application 384, and any other suitable and/or similar application. At least a part of the programming module 300 may be implemented by instructions stored in a non-transitory computer-readable storage medium. When the instructions are executed by one or more processors (e.g., the processor 210), the one or more processors may perform functions corresponding to the instructions. The non-transitory computer-readable storage medium may be, for example, the memory 230. At least a part of the programming module 300 may be implemented (e.g., executed) by, for example, the processor 210. At least a part of the programming module 300 may include, for example, a module, a program, a routine, a set of instructions, and/or a process for performing one or more functions. Names of the elements of the programming module (e.g., the programming module 300) according to an embodiment of the present disclosure may change depending on the type of OS. The programming module according to an embodiment of the present disclosure may include one or more of the above-described elements. Alternatively, some of the above-described elements may be omitted from the programming module. Alternatively, the programming module may further include additional elements. The operations performed by the programming module or other elements according to an embodiment of the present disclosure may be processed in a sequential method, a parallel method, a repetitive method, or a heuristic method. In addition, some of the operations may be omitted, or other operations may be added to the operations.

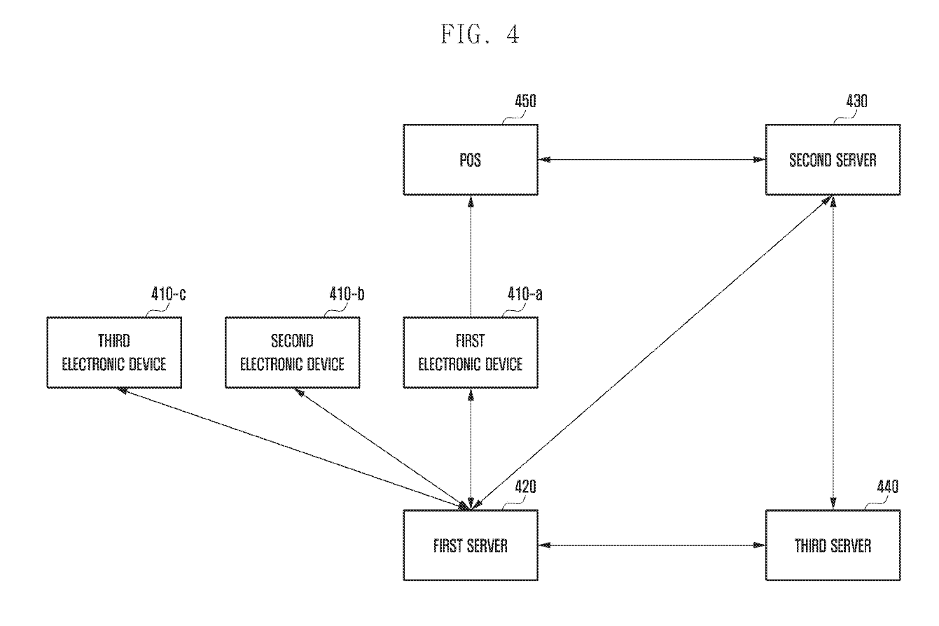

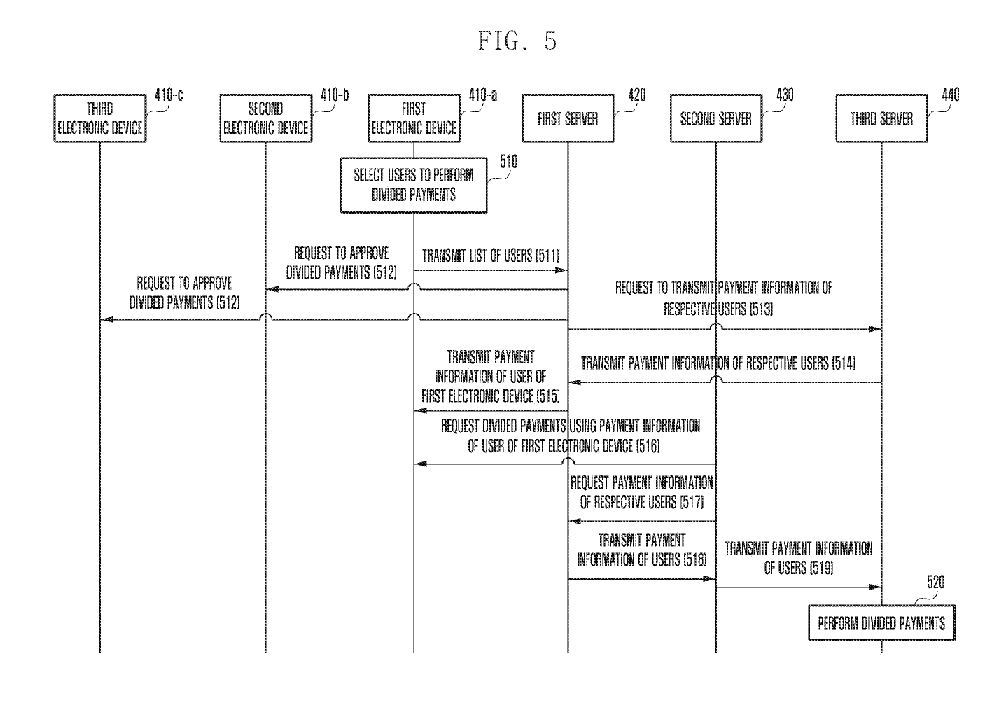

FIG. 4 is a diagram illustrating subjects that perform divided payments according to various embodiments of the disclosure, and FIG. 5 is an operational flowchart illustrating a method for performing divided payments through subjects that perform the divided payments.

Divided payment may mean a payment method in which two or more users make divided payments of a payment amount in paying the payment amount. In performing the divided payments, the divided payment amounts to be paid by the users may be equally designated for the respective users or may be differently designated for the respective users. The payment amounts designated for the respective users may be designated by inputs of the users who perform the divided payments, and if the user inputs for designating the payment amounts are not received, the users who participate in the divided payments may equally designate the payment amounts.

Payment information may include information on payment means for the users to perform the payments. For example, if a user performs the payment by a credit card or a check card, the payment information may include a card number of the credit card or the check card, a card expiration date, and card company information.

With reference to FIG. 4, a divided payment method according to various embodiments of the disclosure may be implemented by a first electronic device 410-a, a second electronic device 410-b, a third electronic device 410-c, a first server 420, a second server 430, a third server 440, and a point of sale (POS) 450. Hereinafter, operations performed by subjects that participate in the divided payments will be described with reference to FIG. 5.

The first electronic device 410-a, the second electronic device 410-b, and the third electronic device 410-c may mean electronic devices corresponding to respective users who participate in divided payments. Hereinafter, for convenience in explanation, a user corresponding to the first electronic device 410-a is defined as a representative who performs the divided payment, a user corresponding to the second electronic device 410-b is defined as user 1, and a user corresponding to the third electronic device 410-c is defined as user 2. In an embodiment illustrated in FIGS. 4 and 5, it is exemplified that three users perform the divided payments, but the number of users capable of performing the divided payments is not limited thereto.

The first electronic device 410-a may receive a user input for selecting users to perform the divided payments (510), and it may transmit data including a list of users to perform the divided payments to the first server 420 (511). In an example illustrated in FIG. 4, users to perform the divided payments may correspond to a representative, user 1, and user 2. The electronic device corresponding to the representative may designate the users (user 1 and user 2) to perform the divided payments, and may further designate payment amounts to be paid by the users to perform the divided payments.

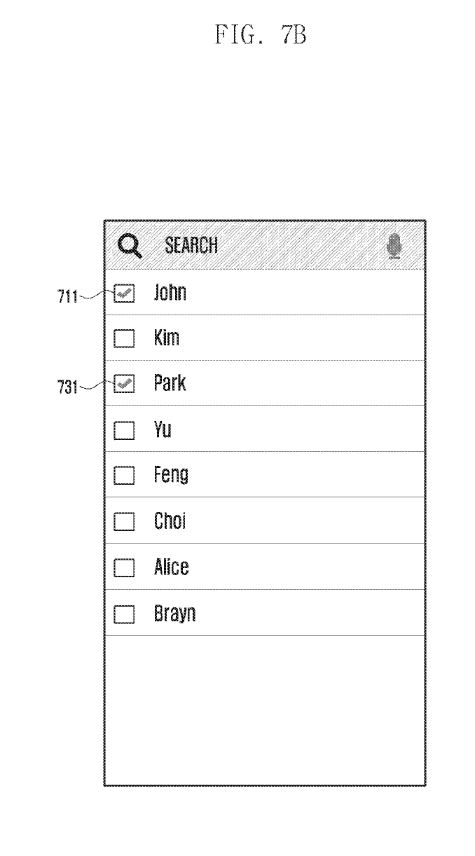

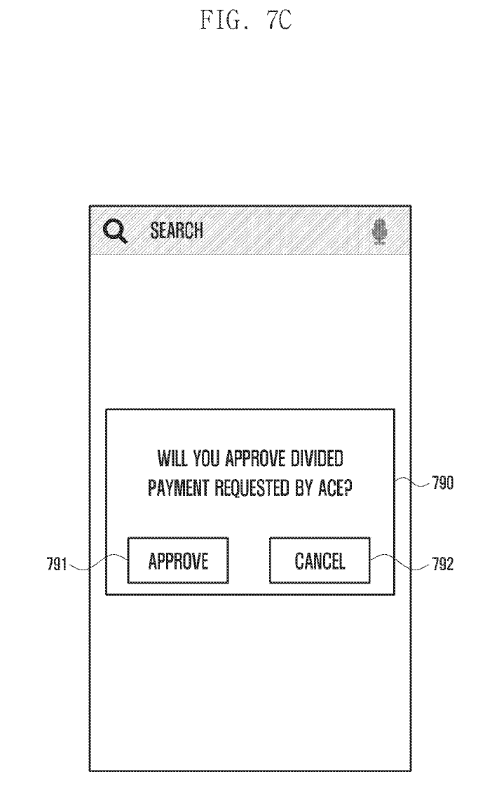

The first electronic device 410-a may output a screen for selecting users to perform the divided payments on a display in order to provide a list of users to perform the divided payments (510). The first electronic device 410-a may provide the list of users to perform the divided payments corresponding to the user input for selecting the users to perform the divided payments, and it may transmit data including the list of users to perform the divided payments to the first server 420 (511). The detailed explanation thereof will be made with reference to FIGS. 7A to 7B.

The list of users to perform the divided payments may be extracted from an address book pre-stored in the first electronic device 410-a, but it is not limited thereto. According to various embodiments of the disclosure, the first electronic device 410-a may collect a list of electronic devices existing in a predetermined range based on the location of the first electronic device 410-a using a near field communication included in the first electronic device 410-a, and it may provide the list of users to perform the divided payments using the collected list.

In the data including the list of users to perform the divided payments, information for identifying the users may be included. For example, the information for identifying the users may include numbers of portable terminals corresponding to the respective users and identifiers (ID) corresponding to the respective users.

In various embodiments of the disclosure, in the data including the list of users to perform the divided payments, divided payment amounts and payment amounts allocated to the respective users.

The first server 420 may transmit messages for requesting to approve the divided payments to the second electronic device 410-b and the third electronic device 410-c that are electronic devices corresponding to the users included in the list of users to perform the divided payments (513).

The second electronic device 410-b and the third electronic device 410-c may receive the messages for requesting to approve the divided payments, and after the approval, they may transmit messages for notifying of the approval to the first server 420.

If the users to perform the divided payments have approved the divided payments, the first server 420 may request the third server 440 to provide payment information corresponding to the users (representative, user 1, and user 2) (513).

The third server 440 may correspond to a server for storing the payment information used for the payments. The payment information may include information on a payment means. For example, if the payment means is a card, the payment information may include a card number and a card expiration date. As another example, if the payment means is a bankbook, the payment information may include a bankbook number.

In particular, the third server 440 may receive a message for requesting the payment information from the first server 420, and it may transmit the payment information to the first server 420 in response to reception of the message for requesting the payment information (514).

According to various embodiments of the disclosure, the third server 440 may process the payment information. According to an embodiment of the disclosure, the third server 440 may provide one-time payment information by processing the payment information so as to effectively use the payment information only for a predetermined time. The provided one-time payment information may be transmitted to the first server 420. According to an embodiment illustrated in FIGS. 4 and 5, the third server 440 may transmit, to the first server 420, payment information corresponding to the representative, payment information corresponding to user 1, and payment information corresponding to user 2. According to various embodiments of the disclosure, the third server may mean a server included in a card company or a bank.

The third server 440 may provide payment information for divided payments. The payment information for the divided payments may be payment information that is different from payment information for normal payment (payment performed by only the user of the first electronic device). According to an embodiment of the disclosure, the payment information for the divided payments may additionally include a flag for indicating the divided payments in addition to the payment information for the normal payment.

The first server 420 may store the payment information of the users using the divided payments transmitted by the third server 440, and it may transmit the payment information corresponding to the user of the first electronic device 410-a to the first electronic device 410-a (515). The first server 420 may transmit the payment information corresponding to the user of the first electronic device 410-a, but it may not transmit the payment information corresponding to the user of the second electronic device 410-b and the payment information corresponding to the user of the third electronic device 410-c. Through this, the payment information of other users is not stored in the first electronic device 410-a corresponding to the representative, and thus user's payment information is not exposed by an ill-intentioned representative.

The first electronic device 410-a may receive the payment information corresponding to the user of the first electronic device 410-a, and it may perform the divided payment using the received payment information corresponding to the user of the first electronic device 410-a (516).

According to an embodiment of the disclosure, the first electronic device 410-a may perform the divided payment by transmitting the payment information corresponding to the user of the first electronic device 410-a to the POS 450. The POS 450 may mean a payment terminal performing the payment. The POS 450 may be a terminal having a combined function of a cash register and a computer terminal, and it may be a payment terminal which not only settles the amount sold but also collects and processes various kinds of information and data that are necessary for retail trade. Further, the POS 450 may be a terminal corresponding to a personal computer (PC) with a card payment device for storing data, such as article names and prices, at a point of purchase, or it may be a terminal performing payments, such as a credit authorization terminal (CAT).

According to another embodiment of the disclosure, the first electronic device 410-a may transmit the payment information to the second server 430 rather than to the POS 450 to perform the divided payments. In this case, the divided payment performed by the first electronic device may be a payment made in an e-commerce process that is performed online rather than offline.

The second server 430 may mean a server that intermediates a transaction between the POS 450 and the third server 440. If the POS 450 requests a divided payment approval, the second server 430 may request the third server 440 to approve the payment based on payment information and card information of users who participate in the divided payments. According to an embodiment of the disclosure, the second server 430 may be connected to the POS 450 and the third server 440 through a value added network (VAN).

If the payment information of the user of the first electronic device is received, the second server 430 may request the first server 420 to provide payment information of the remaining users excluding the representative who is the user of the first electronic device among the users participating in the divided payments (517).

If the payment information of the user of the first electronic device is received, the second server 430 may determine whether the payment to be performed is the payment performed by only the user of the first electronic device or the divided payment. According to an embodiment of the disclosure, the second server 430 may identify a flag indicating whether to perform the divided payments being included in the payment information of the user of the first electronic device. The second server 430 may identify the payment information of the user of the first electronic device, and it may determine to perform the divided payments. If it is determined to perform the divided payments, the second server 430 may request the first server 420 to provide the payment information of the remaining users excluding the representative who is the user of the first electronic device among the users who perform the divided payments.

The first server 420 may transmit the payment information of the users stored in the first server 420 to the second server 430 in response to the request for the payment information of the users transmitted by the second server 430 (518).

According to an embodiment of the disclosure, the first server 420 may determine effectiveness of the payment information corresponding to the user of the first electronic device transmitted by the second server 430. If the payment information corresponding to the user of the first electronic device is effective, the first server 420 may transmit the payment information of the users stored in the first server 420 to the second server 430.

The second server 430 may transmit, to the third server 440, the payment information of the users and the payment information of the representative (the user of the first electronic device) received from the first server 420, and it may request approval of the divided payments (519).

The third server 440 may perform the divided payments based on the payment information of the representative and the payment information of the users participating in the divided payments (520). Although one third server 440 is illustrated in FIG. 5, a plurality of third servers may be provided in accordance with the numbers of card companies and banks used by the users performing the divided payments. For example, if it is assumed that a card company used by the representative is A, a card company used by the user of the second electronic device is B, and a card company used by the user of the third electronic device is C, the third server may exist in each of the card companies A, B, and C.

In the case of the above-described divided payment method, even once a payment request by the representative (first electronic device) enables other users (second electronic device and third electronic device) to perform the payments. In particular, if the payment information of the representative is received, the first server 420 is configured to transmit the payment information of other users to the second server 430, and thus the third server 440 can simultaneously perform the payments for the representative and other users. Accordingly, it is not required for a plurality of persons to wait for their turns to make the divided payments, and thus the inconvenience caused by the waiting to make the divided payments can be resolved.

If it is assumed that three users make divided payments of a payment amount of 24 dollars, according to the existing technology related to the divided payments, a representative pays 24 dollars, and then each of two remaining users remits 8 dollars to the representative. However, according to an embodiment of the disclosure, the divided payments are made in a manner that each of the representative and two users directly pay 8 dollars. This is because the third server 440 can perform the divided payments through reception of the payment information of all the users.

Although FIGS. 4 and 5 illustrate that the first server 420, the second server 430, and the third server 440 perform the divided payments as separate subjects, at least one server may perform all the operations of the first to third servers 420, 430, and 440. Further, two servers may dividedly perform the operations of the first to third servers 420, 430, and 440.

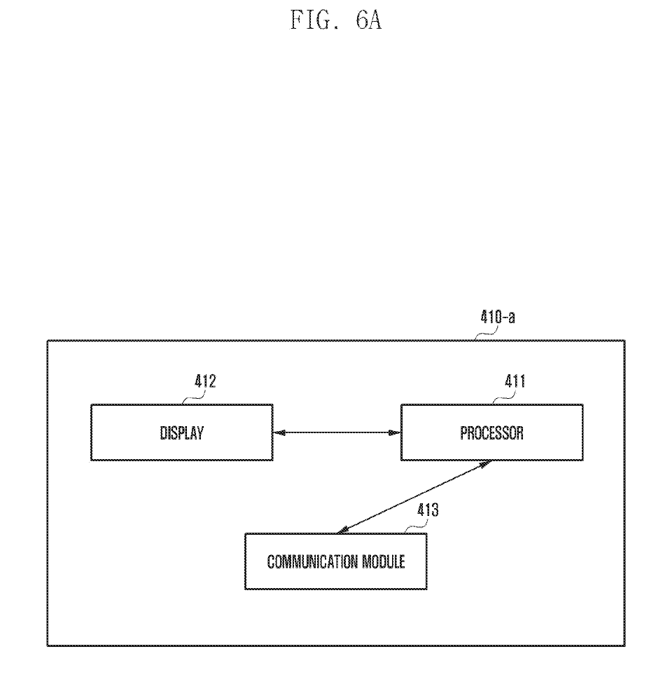

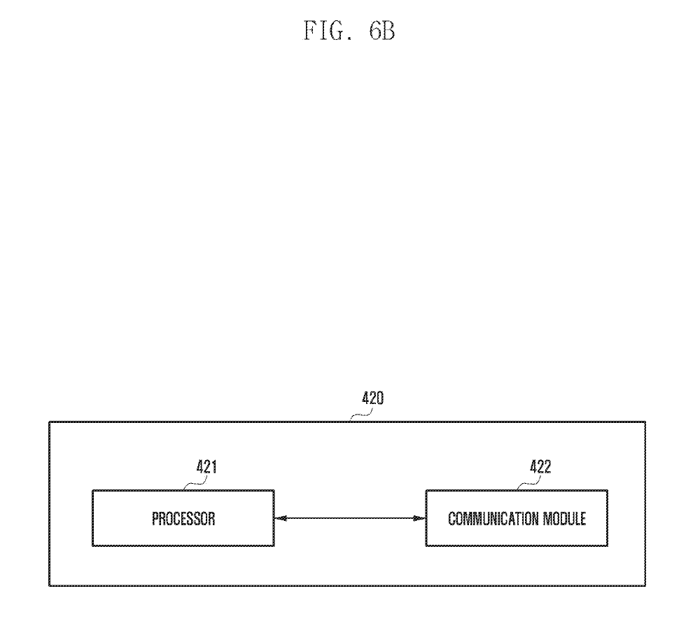

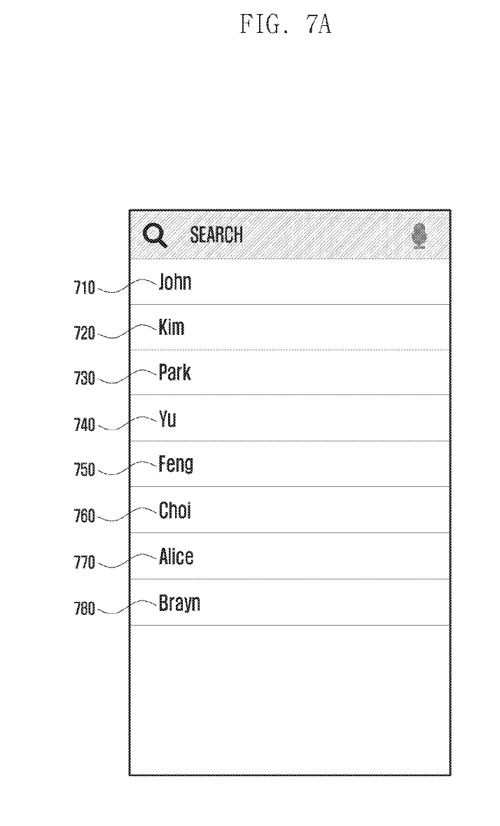

FIG. 6A is a block diagram illustrating the configuration of a first electronic device 410-a corresponding to the representative among subjects that perform the divided payments as illustrated in FIG. 4.

According to various embodiments of the disclosure, the first electronic device 410-a may include a processor 411, a display 412, and a communication module 413.

The processor 411 may control to transmit, to the first server 420, data including a list of users, including a user of the first electronic device 410-a, to perform divided payments.

The processor 411 may control the communication module 413 to transmit, to the first server 420, data including payment amounts to be paid by respective users to perform the divided payments.

The processor 411 may control the communication module 413 to transmit, to the first server 420, a message for requesting the first server 420 to acquire payment information of the users to perform the divided payments.

The processor 411 may control the communication module 413 to transmit, to the first server 420, a message for requesting to transmit the payment information of the user of the first electronic device 410-a that is stored in the first server 420, and it may control to perform the divided payments using the payment information of the user of the first electronic device 410-a. As described above, the first electronic device 410-a can receive the payment information of the user of the first electronic device 410-a, but it does not receive the payment information of the users of the second electronic device 410-b and the third electronic device 410-c, resulting in that security can be heightened in performing the divided payments.

If the first server 420 receives the payment information of the user of the first electronic device 410-a from the second server 430, the processor 411 may control the communication module 413 to transmit a message for requesting the first server 420 to transmit the respective payment information of the users to perform the divided payments to the second server 430.

The payment information according to an embodiment of the disclosure may include card information and account information used by the users to perform the divided payments for their payments, and it may mean payment information temporarily provided to be used in a predetermined period of time.

FIG. 6B is a block diagram illustrating the configuration of a first server 420 among subjects that perform the divided payments as illustrated in FIG. 4.

According to various embodiments of the disclosure, the first server 420 may include a processor 421 and a communication module 422.

The communication module 422 may receive data including a list of users to perform the divided payments from the electronic device. Further, the communication module 422 may receive data related to payment amounts to be shared by the respective users to perform the divided payments.

The processor 421 may request the third server 440 to provide the payment information corresponding to the respective users included in the list, and it may control the communication module 422 to receive the payment information corresponding to the respective users included in the list from the third server 440.

According to an embodiment of the disclosure, the processor 421 may control the communication module 422 to transmit a message for requesting to identify whether the divided payments have been approved to the electronic devices (second electronic device and third electronic device) corresponding to the respective users included in the list. If the electronic devices (second electronic device and third electronic device) corresponding to the respective users included in the list receive the message transmitted to approve the divided payments, the processor 421 may request the third server 440 to provide the payment information corresponding to the respective users.

The processor 421 may control the communication module 422 to transmit, to the electronic device, user's payment information corresponding to the electronic device among the payment information of the users included in the list.

If the payment information corresponding to the user of the electronic device, which is transmitted by the second server 430, is received, the processor 421 may transmit, to the second server 430, the payment information of the at least one remaining user excluding the user of the electronic device. According to another embodiment of the disclosure, if the payment information corresponding to the user of the electronic device, which is transmitted by the second server 430, is received, the processor 421 may transmit, to the second server 430, the payment information of all the users included in the list. According to still another embodiment of the disclosure, if an effectiveness verification request for the payment information corresponding to the user of the electronic device, which is transmitted by the second server 430, is received, the processor 421 may verify the effectiveness of the payment information corresponding to the user of the electronic device, which is transmitted by the second server 430. If the payment information corresponding to the user of the electronic device, which is transmitted by the second server 430, is effective, the processor 421 may transmit the payment information of all the users included in the list to the second server 430.

FIGS. 7A and 7B are diagrams illustrating embodiments of a screen for selecting users who perform divided payments.

As described above with reference to FIGS. 4 and 5, the user of the first electronic device 410-a may select users who perform divided payments. The first electronic device 410-a may display a screen for selecting the users who perform the divided payments on the display 412. FIG. 7A is a diagram illustrating an embodiment of a screen for selecting the users who perform the divided payments.

With reference to FIG. 7A, contact addresses 710 to 780 stored in the first electronic device 410-a are illustrated. Among the contact addresses stored in the first electronic device 410-a, the users to perform the divided payments may be selected using a user's touch input on the display 412 of the first electronic device 410-a. According to an embodiment of the disclosure, a user (or representative) may select the users to perform the divided payments by making a long-press touch input onto the contact addresses 710 to 780 on the screen being displayed on the display 412.

FIG. 7B is a diagram illustrating an embodiment of a screen for selecting the users who perform the divided payments. In FIG. 7B, a situation is assumed, in which a user selects the contact addresses 710 and 730 corresponding to the users to perform the divided payments among the contact addresses 710 to 780.

With reference to FIG. 7B, the electronic device may simultaneously display the contact addresses 710 and 730 corresponding to the users to perform the divided payments and separate indications 711 and 731 indicating the users to perform the divided payments in respective areas adjacent to the contact addresses 710 and 730. Although FIG. 7B illustrates the separate indications 711 and 731 in the form of checks, the disclosure is not limited thereto. For example, it is also possible to indicate the users to perform the divided payments using separate indications in a manner that the size or the thickness of characters corresponding to the contact addresses 710 and 730 corresponding to the users to perform the divided payments is increased.

FIG. 7C is a diagram illustrating an embodiment of a screen for approving divided payments through electronic devices corresponding to users who perform the divided payments.

With reference to FIG. 7C, the electronic device according to an embodiment of the disclosure (e.g., second electronic device 410-b or third electronic device 410-c) may output a message for asking whether to approve the divided payments on the display of the electronic device corresponding to one of the users who perform the divided payments.

The electronic device may transmit a message for indicating approval of the divided payments to the first server 420 in response to a user's approval input (touch input) 791 with respect to the message for asking whether to approve the divided payments.

The electronic device may transmit a message for indicating rejection of the divided payments to the first server 420 in response to a user's rejection input (touch input) 792 with respect to the message for asking whether to approve the divided payments.

According to various embodiments of the disclosure, an electronic device may include a display; a communication module; and a processor configured to control the communication module to transmit, to a first server, data including a list of users, including a user of the electronic device, to perform divided payments, request the first server to acquire payment information corresponding to the respective users to perform the divided payments, and control the communication module to receive payment information corresponding to the user of the electronic device among the payment information corresponding to the respective users to perform the divided payments.

In the electronic device according to various embodiments of the disclosure, the processor may be configured to control the communication module to receive a user input for selecting whether to perform the divided payments, and control the display to display a screen for selecting the users to perform the divided payments based on the divided payments being performed.

In the electronic device according to various embodiments of the disclosure, the processor may be configured to control the communication module to transmit, to the server, data indicating whether to perform the divided payments.

In the electronic device according to various embodiments of the disclosure, the processor may be configured to control the communication module to transmit, to the first server, the payment information of the user corresponding to the electronic device corresponding to a start of the divided payments, and control the communication module to transmit a message for requesting to transmit, to a second server, the payment information of the respective users to perform the divided payments, excluding the payment information of the user of the electronic device, if the first server receives the payment information corresponding to the user of the electronic device from the second server.

In the electronic device according to various embodiments of the disclosure, the processor may be configured to control the communication module to transmit, to the first server, a message for requesting to transmit the payment information of the respective users to perform the divided payments if the first server determines that the payment information corresponding to the user of the electronic device is effective.

In the electronic device according to various embodiments of the disclosure, the processor may be configured to identify whether the respective users have approved, and control the communication module to transmit a message for requesting the first server to store the payment information corresponding to the respective users if the users have approved.

In the electronic device according to various embodiments of the disclosure, the [112] payment information may be temporary payment information usable in a predetermined period of time.

According to various embodiments of the disclosure, an electronic device may include a communication module configured to perform communication with an external electronic device; and a processor configured to control the communication module to receive, from the external electronic device, data including a list of users to perform divided payments, acquire payment information corresponding to the respective users included in the list, transmit, to the electronic device, payment information corresponding to a user of the electronic device, and transmit, to a second external server, payment information corresponding to the at least one remaining user in response to reception of the payment information, corresponding to the user of the electronic device, transmitted from a first external server.

In the electronic device according to various embodiments of the disclosure, the processor may be configured to control the communication module to transmit, to the second external server, the payment information of the users to perform the divided payments in response to the reception of the payment information, corresponding to the user of the electronic device, transmitted from the first external server.

In the electronic device according to various embodiments of the disclosure, the processor may be configured to control the communication module to transmit a message for requesting to identify whether the divided payments have been approved to electronic devices corresponding to the respective users included in the list, and request the second external server to transmit the payment information corresponding to the respective users based on whether the divided payments have been approved.

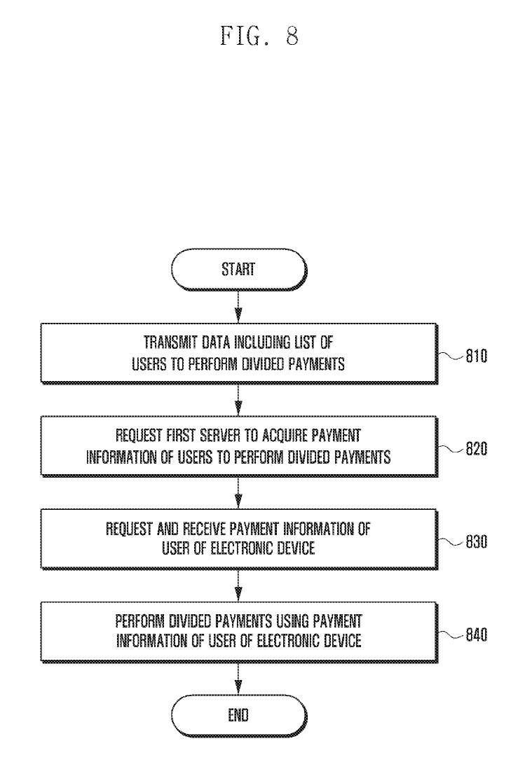

FIG. 8 is a diagram illustrating an operating method of an electronic device according to an embodiment of the disclosure.

With reference to FIG. 8, according to an operating method of an electronic device according to an embodiment of the disclosure, data including a list of users who will perform divided payments may be first transmitted to a first server 420 (810).

The electronic device may transmit, to the first server 420, a message for requesting the first server 420 to acquire payment information of users to perform divided payments (820).

The electronic device may request to transmit payment information corresponding to a user of the electronic device, and it may receive the payment information corresponding to the user of the electronic device (830).

The electronic device may perform the divided payment using the received payment information corresponding to the user of the electronic device (840).

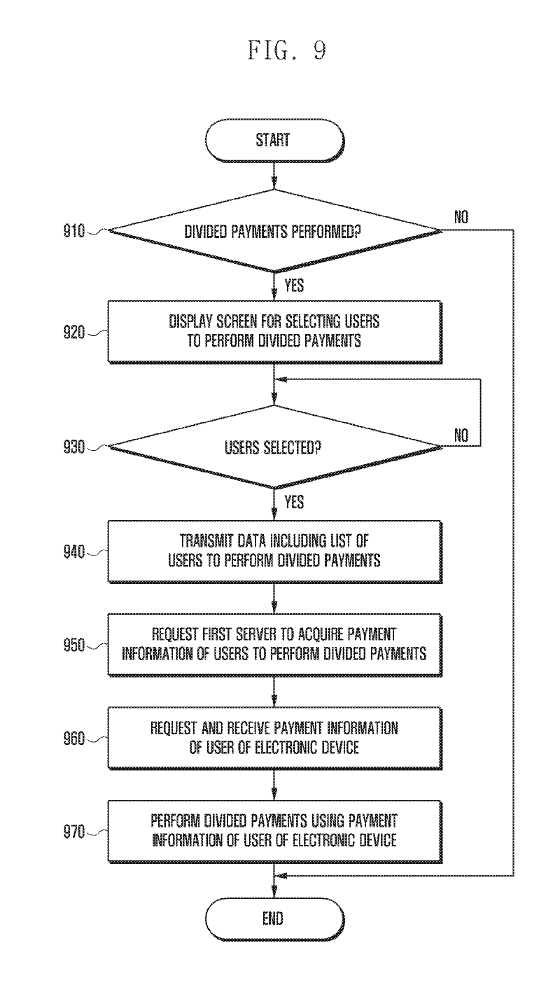

FIG. 9 is a diagram illustrating an operating method of an electronic device according to another embodiment of the disclosure.

With reference to FIG. 9, according to an operating method of an electronic device according to another embodiment of the disclosure, it may be first identified whether to perform divided payments (910).

In the case of performing the divided payments, the electronic device may display a screen for selecting users to perform the divided payments (920). The screen for selecting the users to perform the divided payments has been described with reference to FIGS. 7A and 7B.

The electronic device may identify whether the users to perform the divided payments have been selected (930), and if the users to perform the divided payments have been selected, the electronic device may provide a list of users to perform the divided payments and it may transmit data including the list of users to perform the divided payments to the first server 420 (940).

The electronic device may transmit, to the first server 420, a message for requesting the first server 420 to acquire payment information of the users to perform the divided payments (950).

The electronic device may request to transmit the payment information corresponding to the user of the electronic device, and it may receive the payment information corresponding to the user of the electronic device (960).

The electronic device may perform the divided payment using the received payment information corresponding to the user of the electronic device (970).

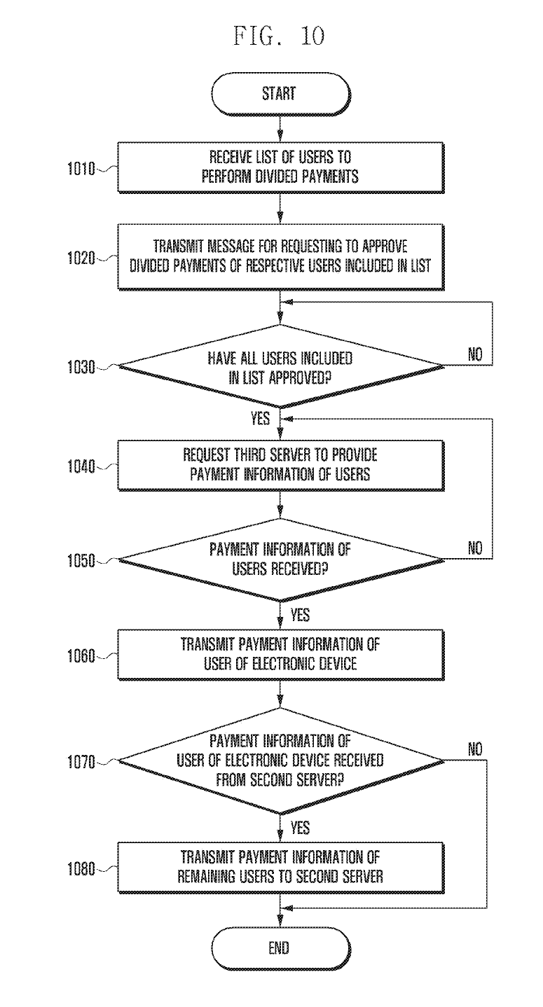

FIG. 10 is a diagram illustrating an operating method of a first server used to perform a divided payment through an electronic device according to various embodiments of the disclosure.

With reference to FIG. 10, according to the operating method of the first server in the divided payment method according to various embodiments of the disclosure, a list of users to perform divided payments may be first received (1010).

The first server may transmit messages for requesting to approve the divided payments for the users included in the list (1020).

The first server may identify whether all the users included in the list have approved the divided payments (1030), and if the users included in the list have approved the divided payments, the first server may request the third server 440 to provide the payment information of the users (1040).

The first server may identify whether the payment information of the users has been received (1050), and if the payment information of the users has been received, the first server may transmit, to the first electronic device 410-a, payment information of the user of the electronic device among the payment information of the users to perform the divided payments (1060).

The first server may identify whether the payment information of the user of the electronic device, which is transmitted by the second server 430, has been received (1070), and if the payment information of the user of the electronic device has been received, the first server may transmit the payment information of the remaining users to the second server 430.

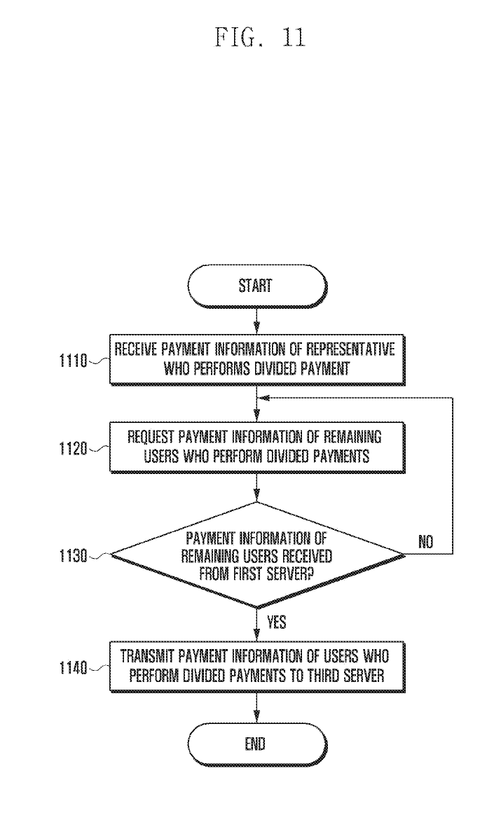

FIG. 11 is a diagram illustrating an operating method of a second server used to perform a divided payment through an electronic device according to various embodiments of the disclosure.

With reference to FIG. 11, according to the operating method of the second server in the divided payment method according to various embodiments of the disclosure, the second server may first receive payment information of a representative (it may correspond to a first electronic device 410-a in an example of FIGS. 4 and 5) who performs a divided payment (1110).

According to an embodiment of the disclosure, the POS 450 may transmit the payment information of the representative who performs the divided payment through a VAN. According to another embodiment of the disclosure, the first electronic device 410-a may also transmit the payment information of the representative who performs the divided payment.

If the payment information of the representative who performs the divided payment is received, the second server may request the first server 420 to provide payment information of the remaining users who perform divided payments (1120).

According to an embodiment of the disclosure, the second server may determine that the divided payments are performed based on data indicating the divided payments included in the payment information of the representative who performs the divided payment, and it may request the payment information of the remaining users who perform the divided payments.

The second server may identify whether the payment information of the remaining users, which is transmitted by the first server 420, has been received (1130), and if the payment information of the remaining users has been received, the second server may transmit, to the third server 440, the payment information of the users (including the representative and the remaining users) who perform the divided payments (1140).

The third server 440 may perform the divided payments based on the payment information of the users who perform the divided payments.

According to various embodiments of the disclosure, a method for performing a payment of an electronic device may include transmitting, to a first server, data including a list of users, including a user of the electronic device, to perform divided payments; requesting the first server to acquire payment information corresponding to the respective users to perform the divided payments; and transmitting a message for requesting payment information corresponding to the user of the electronic device to the first server, and receiving the payment information corresponding to the user of the electronic device.

The method according to various embodiments of the disclosure may further include receiving a user input for selecting whether to perform the divided payments; and displaying a screen for selecting at least one user to perform the divided payments based on the divided payments being performed.

In the method according to various embodiments of the disclosure, the data may include data indicating whether to perform the divided payments.

The method according to various embodiments of the disclosure may further include transmitting a message for requesting to transmit, to a second server, the payment information of the respective users to perform the divided payments, excluding the payment information of the user of the electronic device, if the first server receives the payment information corresponding to the user of the electronic device from the second server.

In the method according to various embodiments of the disclosure, transmitting the message may include transmitting a message for requesting to transmit the payment information of the respective users to perform the divided payments if the payment information corresponding to the user of the electronic device is effective.

The method according to various embodiments of the disclosure may further include controlling a communication module to transmit a message for requesting to identify whether the divided payments have been approved to electronic devices corresponding to the respective users to perform the divided payments, and requesting the payment information corresponding to the respective users based on whether the divided payments have been approved.

In the method according to various embodiments of the disclosure, the payment information may be temporary payment information usable in a predetermined period of time.

According to various embodiments of the disclosure, a method for performing a payment of an electronic device may include receiving, from the electronic device, data including a list of users to perform divided payments; acquiring payment information corresponding to the respective users included in the list; transmitting, to the electronic device, payment information corresponding to a user of the electronic device; and transmitting, to a second external server, payment information corresponding to the at least one remaining user in response to reception of the payment information, corresponding to the user of the electronic device, transmitted from a first external server.

The method according to various embodiments of the disclosure may further include transmitting, to the second external server, the payment information of the users to perform the divided payments in response to the reception of the payment information, corresponding to the user of the electronic device, transmitted from the first external server.

The method according to various embodiments of the disclosure may further include transmitting a message for requesting to identify whether the divided payments have been approved to electronic devices corresponding to the respective users included in the list; and requesting the second external server to provide the payment information corresponding to the respective users based on whether the divided payments have been approved.

The term “module” used in the present disclosure may refer to, for example, a unit including one or more combinations of hardware, software, and firmware. The “module” may be interchangeable with a term, such as “unit,” “logic,” “logical block,” “component,” “circuit,” and the like. The “module” may be a minimum unit of a component formed as one body or a part thereof. The “module” may be a minimum unit for performing one or more functions or a part thereof. The “module” may be implemented mechanically or electronically. For example, the “module” according to an example embodiment of the present disclosure may include at least one of a dedicated processor, a CPU, an application-specific integrated circuit (ASIC) chip, a field-programmable gate array (FPGA), and a programmable-logic device for performing certain operations which have been known or are to be developed in the future.

1. An electronic device comprising:
a display;
a communication module; and
a processor configured to control the communication module to transmit, to a first server, data including a list of users, including a user of the electronic device, to perform divided payments, request the first server to acquire payment information corresponding to the respective users to perform the divided payments, and control the communication module to receive payment information corresponding to the user of the electronic device among the payment information corresponding to the respective users to perform the divided payments.

2. The electronic device of claim 1, wherein the processor is configured to control the communication module to receive a user input for selecting whether to perform the divided payments, and control the display to display a screen for selecting the users to perform the divided payments based on the divided payments being performed.

3. The electronic device of claim 1, wherein the processor is configured to control the communication module to transmit, to the server, data indicating whether to perform the divided payments.

4. The electronic device of claim 1, wherein the processor is configured to control the communication module to transmit, to the first server, the payment information of the user corresponding to the electronic device corresponding to a start of the divided payments, and control the communication module to transmit a message for requesting to transmit, to a second server, the payment information of the respective users to perform the divided payments, excluding the payment information of the user of the electronic device, if the first server receives the payment information corresponding to the user of the electronic device from the second server.

5. The electronic device of claim 4, wherein the processor is configured to control the communication module to transmit, to the first server, a message for requesting to transmit the payment information of the respective users to perform the divided payments if the first server determines that the payment information corresponding to the user of the electronic device is effective.

6. The electronic device of claim 1, wherein the processor is configured to identify whether the respective users have approved, and control the communication module to transmit a message for requesting the first server to store the payment information corresponding to the respective users if the users have approved.

7. The electronic device of claim 1, wherein the payment information is temporary payment information usable in a predetermined period of time.

8. An electronic device comprising:
a communication module configured to perform communication with an external electronic device; and
a processor configured to control the communication module to receive, from the external electronic device, data including a list of users to perform divided payments, acquire payment information corresponding to the respective users included in the list, transmit, to the electronic device, payment information corresponding to a user of the electronic device, and transmit, to a second external server, payment information corresponding to the at least one remaining user in response to reception of the payment information, corresponding to the user of the electronic device, transmitted from a first external server.

9. The electronic device of claim 8, wherein the processor is configured to control the communication module to transmit, to the second external server, the payment information of the users to perform the divided payments in response to the reception of the payment information, corresponding to the user of the electronic device, transmitted from the first external server.

10. The electronic device of claim 8, wherein the processor is configured to control the communication module to transmit a message for requesting to identify whether the divided payments have been approved to electronic devices corresponding to the respective users included in the list, and request the second external server to transmit the payment information corresponding to the respective users based on whether the divided payments have been approved.

11. A method for performing a payment of an electronic device, comprising:
transmitting, to a first server, data including a list of users, including a user of the electronic device, to perform divided payments;
requesting the first server to acquire payment information corresponding to the respective users to perform the divided payments; and
transmitting a message for requesting payment information corresponding to the user of the electronic device to the first server, and receiving the payment information corresponding to the user of the electronic device.

12. The method of claim 11, further comprising:
receiving a user input for selecting whether to perform the divided payments; and
displaying a screen for selecting at least one user to perform the divided payments based on the divided payments being performed.

13. The method of claim 11, wherein the data comprises data indicating whether to perform the divided payments.

14. The method of claim 11, further comprising transmitting a message for requesting to transmit, to a second server, the payment information of the respective users to perform the divided payments, excluding the payment information of the user of the electronic device, if the first server receives the payment information corresponding to the user of the electronic device from the second server.

15. The method of claim 14, wherein transmitting the message comprises transmitting a message for requesting to transmit the payment information of the respective users to perform the divided payments if the payment information corresponding to the user of the electronic device is effective.
